(19) United States
(12) Patent Application Publication
(10) Pub. No.: US 2025/0191795 A1
(43) Pub. Date: Jun. 12, 2025

(54) LEAK DETECTION MESH AND METHODS OF USE THEREOF

(71) Applicant: The Texas A&M University System, College Station, TX (US)

(72) Inventors: Daniel Watson, College Station, TX (US); Pavel Tsvetkov, College Station, TX (US)

(21) Appl. No.: 18/533,608

(22) Filed: Dec. 8, 2023

(51) Int. Cl. G21C 17/00; G01M 3/16

(52) U.S. Cl. CPC G21C 17/002; G01M 3/16

(57) ABSTRACT

A leak detection system includes a leak detection apparatus. The leak detection apparatus includes an electrode mesh and an insulative layer associated with the electrode mesh. The insulative layer is engageable with a conducting fluid containing component. The electrode mesh is configured to output an electric signal responsive to a conducting fluid reaching the electrode mesh through the insulative layer. The leak detection apparatus further includes a computing device configured to receive said electrical signal and associate said electrical signal with a leak event by correlating said electrical signal with a baseline electrical output of the electrode mesh.

### TECHNICAL FIELD

The described examples relate generally to systems, devices, and techniques for detecting leaks in process equipment using external measurement devices.

### BACKGROUND

Process equipment (e.g., tanks, vessels, pipes, pumps, and so on) may be subject to leaks over a period of time. In some cases, such process equipment may carry hazardous substances, including substances that may be radioactive. In this regard, process equipment may be arranged within certain containment structures, barriers, and shielding, which may, among other functions, operate to contain any leaked substance from the process equipment held therein. As one example, process equipment may be used to carry a fissile molten salt material through along a “loop” between a reactor vessel, a pump, and a primary heat exchanger. The reactor vessel, pump(s), heat exchanger(s) and/or other components may be fluidly coupled to one another by a series of pipes, flanges, and other connections, which may each present the possibility for leaks or other failure mechanisms. It may therefore be desirable to detect the presence of a leak from any such process equipment upon the occurrence of said leak event in order to provide information that can be used to take prompt remedial action, if needed. Conventional approaches to leak detection may lack the ability to detect leaks remotely, particularly in high-radiation and high-temperature environments. Further, conventional approaches to leak detection may lack the ability to diagnose leak rate and location in such environments. As such, there remains a need for advanced leak detection systems that allow for leak detection in high-radiation and high temperature environments that can provide information concerning leak rate and location, among other parameters.

### SUMMARY

In one example, a leak detection system is disclosed. The leak detection system includes a leak detection apparatus. The leak detection apparatus includes an electrode mesh and an insulative layer associated with the electrode mesh. The insulative layer is engageable with a conducting fluid containing component. The electrode mesh is configured to output an electric signal responsive to a conducting fluid reaching the electrode mesh through the insulative layer. The leak detection system further includes a computing device configured to receive said electrical signal and associate said electrical signal with a leak event by correlating said electrical signal with a baseline electrical output of the electrode mesh.

In another example, the insulative layer may include an insulative wick. The electrode mesh may include conductive fibers impregnated within the insulative wick.

In another example, the electrode mesh may include a first electrode mesh. The leak detection apparatus may further include a second electrode mesh. The insulative layer may be arranged between the first electrode mesh and the second electrode mesh and electrically insulating the first electrode mesh and the second electrode mesh from one another.

In another example, the second electrode mesh may be arranged against the conducting fluid containing component. The first electrode mesh may generate the electrical signal responsive to the conducting fluid reaching the first electrode mesh through the insulative layer and the second electrode mesh.

In another example, the first electrode mesh may generate the electrical signal responsive to the conducting fluid reducing a resistance between the first electrode mesh and the second electrode mesh.

In another example, the conducting fluid may include a fuel salt including a fissile material therein.

In another example, the conducting fluid may include a natural and/or artificial fluid with an electrical response, including one or more of a liquid metal, water, a nano fluid and/or another fluid.

In another example, the system may further include a plurality of the leak detection apparatuses, such as any of the leak detection apparatuses described herein. The plurality of leak detection apparatuses may be arranged in multi-node configuration with each leak detection apparatus associated with a different fluid containing component, all of which may include the conducting fluid.

In another example, each leak detection apparatus may be configured to output a fluid containing component specific signal responsive the conducting fluid reaching the respective leak detection apparatus via the corresponding fluid containing component associated therewith.

In another example, the electrode mesh may define a multiplexer configuration including one or more layers of linearly pixelated electrodes. The electrode mesh may be configured to output signal indicative of a location of the leak event relative to the fluid containing component.

In another example, a nuclear reactor system is disclosed. The system includes a conducting fluid containing component including a conducting fluid therein. The system further includes a leak detection apparatus engaged with an exterior of the conducting fluid component and configured to produce an electrical signal responsive to a detection of the conducting fluid at the leak detection apparatus. The system further includes a radiation barrier at least partially encompassing the conducing fluid containing component and the leak detection apparatus. The system further includes a computing device, outside of the radiation barrier, and configured to receive said electrical signal and associate said electrical signal with a leak event by correlating said electrical signal with a baseline electrical output of the leak detection apparatus.

In another example, the conducing fluid may include a fuel salt including a fissile material therein.

In another example, the conducting fluid containing component may include a reactor vessel or a piping fluidly coupled therewith for circulation of a fuel salt.

In another example, the radiation barrier may include a reactor vessel.

In another example, the radiation barrier may further include a thermal management vessel within the reactor enclosure. The thermal management vessel may encompass a reactor vessel and a drain tank of a molten salt loop.

In another example, the leak detection apparatus may further include an electrode mesh and an insulative layer associated with the electrode mesh. The insulative layer may be engageable with the conducting fluid containing component. The electrode mesh may be configured to output the electric signal responsive to the conducting fluid reaching the electrode mesh through the insulative layer.

In another example, a method is disclosed. The method includes operating a conducting fluid containing component by propagating a conducting fluid therethrough. The method further includes operating a leak detection apparatus engaged with an exterior of the fuel salt containing component by generating a baseline electrical output therefrom. The method further includes producing an electrical signal responsive to the conducting fluid reaching the leak detection apparatus. The method further includes determining a leak event by correlating said electrical signal with the baseline electrical output.

In another example, the leak detection apparatus may include an electrode mesh and an insulative layer associated with the electrode mesh. The producing of the electrical signal may further include producing said electrical signal responsive to the conducting fluid reaching the electrode mesh through the insulative layer.

In another example, the electrode mesh may include a first electrode mesh. The leak detection apparatus may further include a second electrode mesh. The insulative layer may be arranged between the first electrode mesh and the second electrode mesh and electrically insulating the first electrode mesh and the second electrode mesh from one another. The producing of the electrical signal may further include producing said electrical signal responsive to the conducting fluid reaching the first electrode mesh through the insulative layer and the second electrode mesh and reducing a resistance between the first electrode mesh and the second electrode mesh.

In another example, the determining of the leak may further include determining a location of the leak event relative to a geometry of the conducting fluid containing component.

In another example, the method may further include analyzing the electrical signal outside of a radiation shielding encompassing the conducting fluid containing component and the leak detection apparatus.

In another example, the conducting fluid may include a fuel salt including a fissile material therein.

In another example, the conducting fluid may include a natural and/or artificial fluid with an electrical response, including one or more of a liquid metal, water, a nano fluid and/or another fluid.

In addition to the example aspects described above, further aspects and examples will become apparent by reference to the drawings and by study of the following description.

### BRIEF DESCRIPTION OF THE DRAWINGS

FIG. 1 depicts an example molten salt reactor system.

FIG. 2 depicts an example leak detection apparatus of the molten salt reactor system of FIG. 1.

FIG. 3 depicts a cross-sectional view of a first example of the leak detection apparatus of FIG. 2, taken along line 3-3 of FIG. 2.

FIG. 4 depicts the leak detection apparatus of FIG. 3 during a leak event.

FIG. 5 depicts a cross-sectional view of a second example of the leak detection apparatus of FIG. 2, taken along line 3-3 of FIG. 2.

FIG. 6 depicts the leak detection apparatus of FIG. 5 during a leak event.

FIG. 7 depicts an example leak detection system.

FIG. 8 depicts an example multi-node configuration of the leak detection apparatuses of the present disclosure.

FIG. 9 depicts an example multiplexer configuration of the leak detection apparatuses of the present disclosure.

FIG. 10 depicts a flow diagram of an example method of determining a leak event.

FIG. 11 depicts a functional block diagram of a computing system.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes sample systems, methods, and apparatuses that embody various elements of the present disclosure. However, it should be understood that the described disclosure may be practiced in a variety of forms in addition to those described herein.

The following disclosure relates generally to leak detection apparatuses, systems and methods of use thereof. For example, disclosed herein are certain leak detection systems and apparatuses that may be used to detect a leak (including a location and rate of said leak) of a conducting fluid relative to various types of process equipment. As used herein, “process equipment” may refer to substantially any type of commercial or industrial equipment that is used to move or process a substance, including generally any types of tanks, vessels, pipes, pumps, instrumentation, valves, and so on. In this regard, process equipment may refer herein to equipment that is used to handle fluids associated with energy production, including the production of heat from nuclear reactors, such as molten salt nuclear reactors. In the illustrated examples herein, example process equipment is described in relation to molten salt reactors (MSRs); however, it will be appreciated that this is for purposes of illustration, and that the example leak detection apparatuses, systems and methods of use thereof may be applicable to substantially any other process equipment. The conducting fluid may therefore include a fuel salt including a fissile material therein, and the leak detection apparatuses and systems of the present disclosure may be configured to detect a leak of said fuel salt. Additionally or alternatively, the conducting fluid may comprises a natural and/or artificial fluid with an electrical response, including one or more of a liquid metal, water, a nano fluid and/or another fluid, and the leak detection apparatuses and systems of the present disclosure may be configured to detect a leak of said fluids.

With reference to MSRs, MSRs offer an approach to power that can utilize molten salts as their nuclear fuel in place of the conventional solid fuels used in light water reactors. Advantages include efficient fuel utilization and enhanced safety (in part due to replacing water as a coolant with molten salt). In some MSRs, fission reactions can occur within a molten salt composition housed with a reactor vessel. In certain conventional MSRs, fuel salt undergoes a fission reaction in a reactor vessel. Such conventional MSRs may operate by pumping the fuel salt from the reactor vessel along a “loop,” first to a primary heat exchanger, and then back to the reactor vessel so that the fuel salt may re-enter the reactor vessel for subsequent fission reactions. The reactor vessel, pump(s), heat exchanger(s) and/or other components may be fluidly coupled to one another by a series of pipes, flanges, and other connections, which may each present the possibility for leaks or other failure mechanisms. In some conventional systems, the functional components of the MSR may be arranged fully within an integral enclosure in order to form an integral or “pool-type” reactor whereby the fuel salt circulates between a reactor core and heat exchangers within a common vessel.

Any of the foregoing components, assemblies, subassemblies of such MSRs and so forth may be considered “process equipment,” as used herein. The reactor vessel, pump(s), heat exchanger(s) and/or other components may be fluidly coupled to one another by a series of pipes, flanges, and other connections, which may each present the possibility for leaks or other failure mechanisms. It may therefore be desirable to detect the presence of a leak from any such process equipment upon the occurrence of said leak event in order to provide information that can be used to take prompt remedial action, if needed. Conventional approaches to leak detection may lack the ability to detect leaks remotely, particularly in high-radiation and high-temperature environments. Further, conventional approaches to leak detection may lack the ability to diagnose leak rate and location in such environments. As such, there remains a need for advanced leak detection systems that allow for leak detection in high-radiation and high-temperature environments that can provide information concerning leak rate and location, among other parameters.

To mitigate these and other challenges, disclosed herein are certain leak detection systems and apparatuses that are operable to detect leaks in process equipment of various types, including process equipment arranged in a high-radiation, high-temperature environments. In one example, the leak detection system generally includes a conductive mesh, such as a mesh formed from a series of electrodes. The conductive or “electrode” mesh may be responsive to contact with a conducting fluid (e.g., a molten salt solution) such that upon contact with said conducting fluid an electrical output or parameter of the electrode mesh may change. As one illustration, the electrode mesh may exhibit certain electrical resistance or capacitance, and upon contact with the conducting fluid, the electrical resistance or capacitance of the electrode mesh may change. In some cases, the change in the electrical resistance or capacitance may be proportional or otherwise correlated to a magnitude of the conducting fluid that contacts the electrode mesh and/or a location of said contact of the conducting fluid, as described in greater detail herein. Further, the change in electrical resistance, capacitance and/or other parameter may generally occur and be detectable notwithstanding the arrangement of the electrode mesh in a high-radiation or high-temperature environment. The electrode mesh may therefore be arranged proximal to certain process equipment, including process equipment of a MSR that may be arranged in a high-radiation or high-temperature environment, to detect leaks of any conducting fluid emanating therefrom.

To facilitate the foregoing, the electrode mesh may be associated with an insulative material. The insulative material may be a fabric material, such as a Kaowool ceramic insulation or like material, that does not conduct electrical current therethrough. The fabric material may be substantially permeable or otherwise adapted to absorb and hold a quantity of fluid therein. In one example, the insulative material may serve as barrier between the electrode mesh and the associated process equipment. In this regard, the insulative material may be configured to absorb at least some conducting fluid of any conducting that leaks from said conducting fluid. The conducting fluid absorbed into the insulative material may, in turn, propagate therethrough and toward the electrode mesh. Upon contact of the conducting fluid with the electrode mesh, the electrode mesh may exhibit a change in an electrical parameter, as described herein, which may be indicative of a leak event, including being indicative of a location and magnitude of the leak.

The insulative material may also serve as a structural layer to the electrode mesh. For example, the insulative material may have a rigidity and/or material strength that may be greater than the electrode mesh. As such, the electrode mesh may be associated with the insulative material to form a composite apparatus for attachment with the process equipment, as described in greater detail below.

Various example electrode meshes are described and contemplated herein. In one example, the electrode mesh may include a collection of conductive fibers impregnated within an insulative wick formed by the insulative material. In such example, the conducting fluid may propagate through the insulative wick, upon the occurrence of a leak event, and reach the conductive fibers held therein. Upon reaching the conductive fibers, the conductive fibers may generate an electrical response indicative of said detection, according to the methods described herein. In another example, the electrode mesh may include a first electrode mesh layer and a second electrode mesh layer. The insulative material may be arranged substantially between the first and second electrode mesh layer and serve to electrically insulate the electrode mesh layers from one another. In such example, the conducting fluid may propagate through the second electrode mesh layer (i.e., the electrode mesh layer held closest to the process equipment), the insulative material, and then to the first electrode mesh layer (i.e., the electrode mesh layer held against the insulative material opposite the process equipment). Upon a leak event, the conducting fluid may serve to form or complete an electric circuit or electric bridge between the first and second electrode mesh layers. Upon the electrical coupling of the first and second electrode mesh layers, the resistance or other electric parameter of the mesh layers may change, which may be indicative of a detection of a leak event, according to the techniques described herein. In other examples, other arrangements are possible, including in which a single electrode mesh layer and a single insulative layer are used. For example, upon the occurrence of a leak event, the conducting fluid may propagate through the insulative material and complete an electric circuit or electric bridge between the single electric mesh layer and the conducting material of the process equipment (e.g., the metal shell or a tank or vessel, as an example). Analogously, the electrode mesh layer may exhibit a change in an electrical property upon completion of such circuit, which may be indicative of leak event. In other examples, other arrangements are possible and contemplated herein.

The leak detection apparatuses of the present disclosure may be used in cooperation with one or more computing devices in order to establish a leak detection system. For example, the leak detection apparatus, including the electrode mesh and insulative material may be arranged proximal to the process equipment and within a potentially high-radiation and high-temperature environment. Said leak detection apparatus may be electrically coupled to one or more computing systems that are arranged generally outside of the high-radiation and high-temperature environment. For example, the leak detection apparatus may be coupled with the one or more computing systems via a series of cords or cables that extend from the apparatus and transverse a boundary of the high-radiation, high-temperature environment to reach the one or more computing systems. The one or more computing systems may be operable, among other functions, to register a baseline electrical output of the leak detection apparatus, such as an output produced in which the conducting fluid is not in contact with the electrode mesh. In turn, the one or more computing systems may detect a change in the electric output of the leak detection apparatus relative to the baseline and correlate said change with a leak event from the associated process equipment. In some cases, as described herein, the one or more computing devices may further be operable to determine magnitude, rate, location and/or other parameter associated with the leak event.

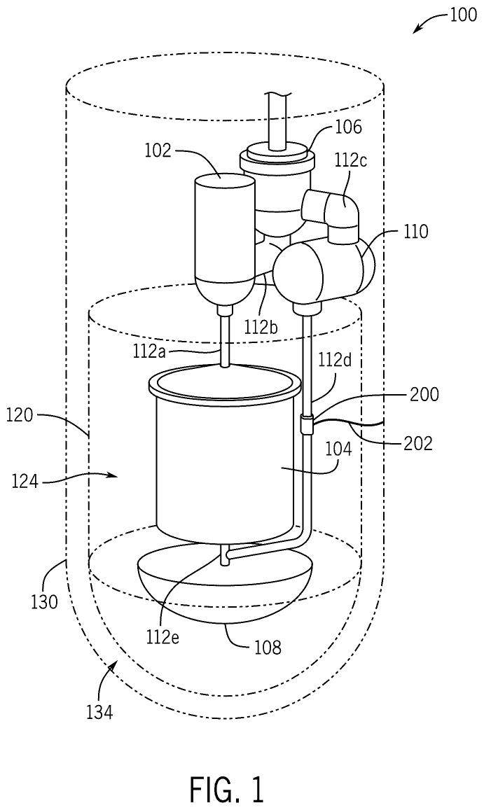

Turning to the Drawings, FIG. 1 depicts an example molten salt reactor system 100. The molten salt reactor system 100 is depicted and described herein to illustrate example process equipment with which the various leak detection apparatuses and systems of the present disclosure may be used. Accordingly, while the molten salt reactor system 100 is described herein, it will be appreciated that such leak detection apparatuses and systems may be used with a variety of process equipment to detect leaks of conducting fluid being carried therethrough, as described herein.

With reference to the molten salt reactor system 100 of FIG. 1, the example molten salt reactor system 100 of FIG. 1 utilizes fuel salt enriched with uranium (e.g., high-assay low-enriched uranium) to create thermal power via nuclear fission reactions. In at least one example, the composition of the fuel salt may be LiF—BeF₂—UF₄, though other compositions of fuel salts may be utilized as fuel salts within the reactor system 100. The fuel salt within the system 100 is heated to high temperatures (such as 600° C. or greater) and melts as the system 100 is heated.

As shown in FIG. 1, the molten salt reactor system 100 includes a reactor vessel 104 where the nuclear reactions occur within the molten fuel salt, a fuel salt pump 106 that pumps the molten fuel salt to a heat exchanger 110, such that the molten fuel salt re-enters the reactor vessel after flowing through the heat exchanger 110, and piping in between each component (e.g., piping 112a, 112b, 112c, 112d, 112e). The molten salt reactor system 100 may also include additional components, such as, but not limited to, drain tank 108 and reactor access vessel 102. The drain tank 108 may be configured to store the fuel salt once the fuel salt is in the reactor system 100 but in a subcritical state, and also acts as storage for the fuel salt if power is lost in the system 100. The reactor access vessel 102 may be configured to allow for introduction of small pellets of uranium fluoride (UF₄) to the system 100 as necessary to bring the reactor to a critical state and compensate for depletion of fissile material. In several examples, the molten salt reactor system 100 may include an inert gas system and/or an equalization system (not shown in FIG. 1) to provide inert gas to a head space of the various salt-bearing components of the system 100 and to equalize pressures therebetween as needed for a given operation of the system 100.

FIG. 1 further shows the system 100 as including an internal vessel or shield 120 that defines a first thermally insulative region 124 about select components of the system 100. FIG. 1 further shows the system 100 as including a reactor enclosure 130. The reactor enclosure may be constructed from a thermally insulative metal (including certain stainless steels) that is capable of withstanding substantially high temperatures, such as temperature in excess of 600° C. The reactor enclosure 130 is shown, schematically, as encompassing the entirety of the internal shield 120 and any other salt-bearing components that are not otherwise included with the internal shield 120. For example, the reactor enclosure 130 may define a second thermally insulative region 134 that receives the internal shield 120 and all the salt-bearing components that are not held within the first thermally insulative region 124. The internal shield 120 and the reactor enclosure 130 may therefore each define a containment barrier about the salt-bearing components of the system 100. Further, the internal shield 120 and the reactor enclosure 130 may define a substantially high-radiation and high-temperature zone of the system 100.

As described herein, it may be desirable to detect the presence of any leak of the molten salt or other “conducting fluid” of the system 100 despite the salt-bearing components of the system 100 being in a generally high-radiation or high-temperature environment. In this regard, FIG. 1 further shows a leak detection apparatus 200, such as any of the leak detection apparatuses described herein. The leak detection apparatus 200 may generally be configured to detect the presence of a leak of conducting fluid from the processing equipment with which the leak detection apparatus 200 is associated. For example, the leak detection apparatus 200 may be associated with a pipe segment 112d (e.g., the pipe run that extends between the heat exchanger 110 and the drain tank 108) and be configured to output an electrical signal indicative of a leak event of conducting fluid from the pipe segment 112d, as described herein. While the leak detection apparatus is shown associated with the pipe segment 112d, in other cases, the leak detection apparatus 200 may be associated with substantially any tank, vessel, pipe, pump and/or other component of the system 100 and/or other process equipment, according to the examples described herein. The leak detection apparatus 200 is shown arranged in the high-temperature, high-radiation environment of the system 200. Wire bundle 202 is shown extending from the leak detection apparatus to a zone outside of the high-temperature, high-radiation zone, such as to one or more computing devices that may receive signals from the leak detection apparatus for analysis and determination of any leak events detected therewith.

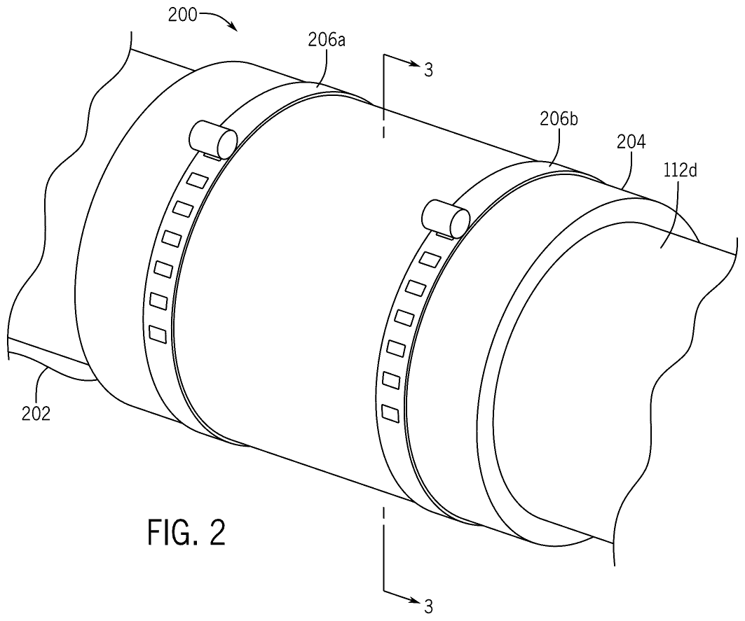

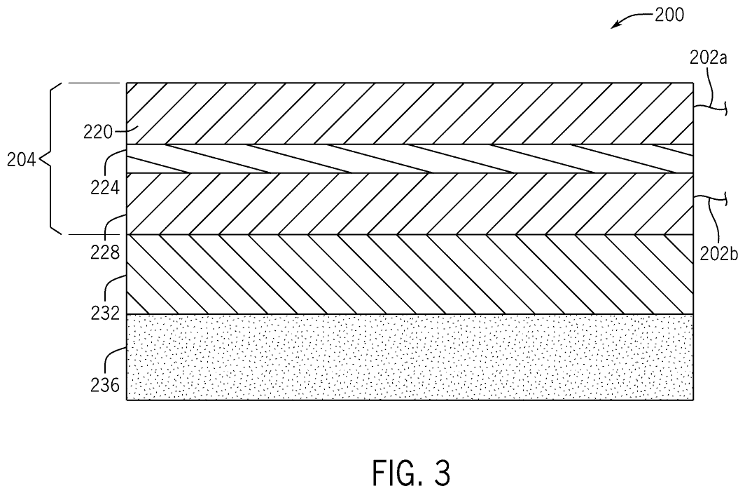

Turning to FIG. 2, the leak detection apparatus 200 is shown in greater detail. The leak detection apparatus 200 may generally include a leak detection composite structure 204. The leak detection composite structure 204 may generally include an insulative material and an electrode mesh, accordingly to various arrangements, such as those shown herein with reference to FIGS. 3-6. The leak detection composite structure 204 may be associated with the pipe segment 112d (or other process equipment) via straps 206a, 206b. The straps 206a, 206b may generally be any type of securing mechanism by which to physically secure the composite structure 204 against the pipe segment 112d such that composite structure 204 physically engages and maintains contact with the pipe segment 112d during operation.

With reference to FIG. 3, a cross-sectional view of a first example of the leak detection apparatus 200 is shown, taken along line 3-3 of FIG. 2. The leak detection apparatus 200 is shown in FIG. 3 with the composite structure 204 including a first electrode mesh 220, an insulative layer 224, and a second electrode mesh 228. The composite structure 204 is further shown with a first wire 202a extending from the first electrode mesh 220 and a second wire 202b extending from the second electrode mesh 228. The composite structure 204 is further shown engaged with an physically coupled to a pipe wall 232. The pipe wall 232 may be a pipe wall of the pipe segment 112d described herein above. The pipe wall 232 may contain a conducting fluid 236, such as a molten salt that flows therein.

The first electrode mesh 220 and the second electrode mesh 228 may form the electrode mesh or electrode mesh assembly of the leak detection apparatus 200. The first electrode mesh 220 and the second electrode mesh 228 may each be formed from an electrically conductive material, including copper, platinum, gold, and other conductive metals. In some cases, the metal construction of the first and second electrode meshes 220, 228 may be based in part on the chemical or corrosive resistivity of the metal such that the meshes 220, 228 may withstand the potentially harsh environment of the system within which the meshes 220, 228 are placed. The meshes 220, 228 may be constructed as a series of metal wires that are linked, woven, or otherwise connected with one another to form a mesh. The construction of a mesh structure may include the defining of holes or passages through the respective meshes 220, 228. The holes or passages through the respective meshes 220, 228 may permit the flow of a conducting fluid therethrough, which may allow the conducting fluid to form a conductive bridge or circuit between the meshes 220, 228, as described herein.

In the example of FIG. 3, the first electrode mesh 220 and the second electrode mesh 228 are arranged with the insulative layer 224 therebetween. The insulative layer 224 may generally be constructed from any material that is considered an electrical insulator or that otherwise impedes or prevents the conducting of electric current therethrough. For example, the insulative layer 224 may be constructed from a Kaowool ceramic fiber insulation or other fabric material that acts as an electrical insulator. The insulative layer 224 may further be constructed from a material that is substantially permeable. For example, the insulative layer 224 may be configured to permit the propagation of the conducting fluid therethrough, which as described herein, may allow for the insulative layer to be electrically bridged whereby the conducting fluid traverses a complete thickness or width of the insulative layer 224.

Wires 202a, 202b are shown in FIG. 3 as extending from the first electrode mesh 220 and the second electrode mesh 228, respectively. The wires 202a, 202b may each be configured to deliver an electric output of the respective electrode mesh to one or more computing systems. For example, the first electrode mesh 220 may output a first electric parameter (e.g., resistance) when not in contact with a conducting fluid, and such first electric parameter may be output to the one or more computing systems via the wire 202a. Further, the second electrode mesh 228 may output a second electric parameter (e.g., resistance) when not in contact with a conducting fluid, and such second electric parameter may be output to the one or more computing systems via the wire 202b. In operation, and as described in greater detail herein, the first and/or second parameter may change responsive to the respective first and second electrode meshes 220, 228 contacting a conducting fluid, and said wires 202a, 202b may carry said changes in the respective parameter to one or more computing system for analysis.

The composite structure 204 is shown in FIG. 3 as engaged with the pipe wall 232. For example, the composite structure 204 may be strapped or otherwise connected to the pipe wall 232 (e.g., via the straps 206a, 206b shown with reference to FIG. 2). In this regard, upon a failure of the pipe wall 232 (e.g., due to corrosion or other failure mechanism), the conducting fluid 236 included therein may reach the composite structure 204. It will be appreciated that various implementations of the composite structure 204 are possible and contemplated herein. While FIG. 3 shows the composite structure 204 as including the first electrode mesh 220, the insulative layer 224, and the second electrode mesh 228, in other cases, more or fewer layers may be used. For example, in one implementation, the second electrode mesh 228 may be omitted entirely, and the composite structure 204 may include the first electrode mesh 220 and the insulative layer 224 such that the insulative layer 224 is directly engaged and contacting the pipe wall 232. In other examples, other arrangements are possible and contemplated herein.

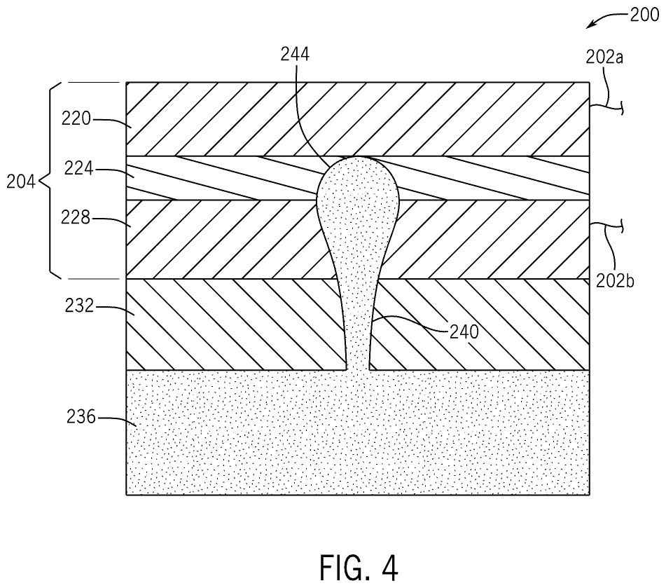

With reference to FIG. 4, the leak detection apparatus 200 is shown during a leak event from the associated pipe wall 232. For example, the conducting fluid 236 retained by the pipe wall 232 may have certain corrosive properties that operate to degrade, and potentially establish a leak in the pipe wall 232, such as via failure passage 240, shown in FIG. 4. The failure passage 240 may represent a breach or other through portion in the pipe wall 232 that allows the conducting fluid 236 to pass therethrough via a leak path 244. In some cases, the failure passage 240 may be substantially small, such that the failure passage 240 shown in FIG. 4 may represent a series of microscopic cracks or other failures in the material of the pipe wall 232 that operate to allow the conducting fluid 236 to travel therethrough.

In operation, the conducting fluid 236 may travel through the failure passage 240 and along the leak path 244 through the composite structure 204. For example, and as shown in FIG. 4, the conducting fluid 236 may travel through the second electrode mesh 228, the insulative layer 224, and the first electrode mesh 220. The conducting fluid 236 may travel through the second electrode mesh 228 to the extent that the second electrode mesh 228 is arranged adjacent to the leak path 244 and given that the second electrode mesh 228 may be a permeable structure with a series of holes or through portions defined interspersed between the various metal electrodes. Further, the conducting fluid 236 may travel through the insulative material 224 to the extent that the insulative material 224 is arranged adjacent the second electrode mesh 228 and given that the insulative material 228 may also be a permeable structure with pores defined by the insulative material 224 that allow for the propagation of a fluid therethrough. Further, the conducting fluid 236 may travel through the first electrode mesh 220 to the extent that the first electrode mesh 220 is arranged adjacent to the insulative material 224 and given that the first electrode mesh 228 may be a permeable structure with a series of holes or through portions defined interspersed between the various metal electrodes.

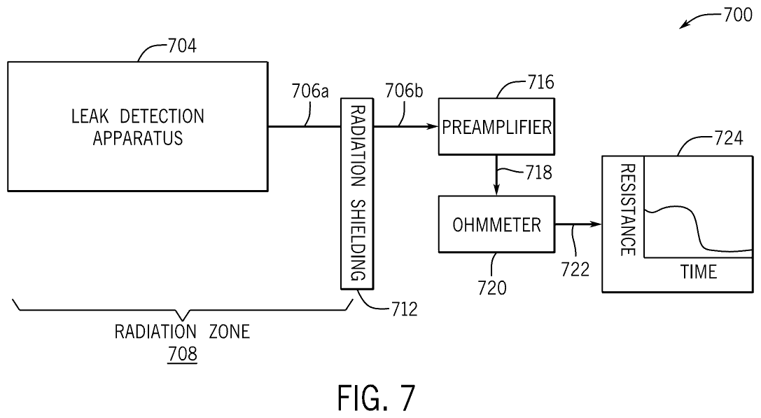

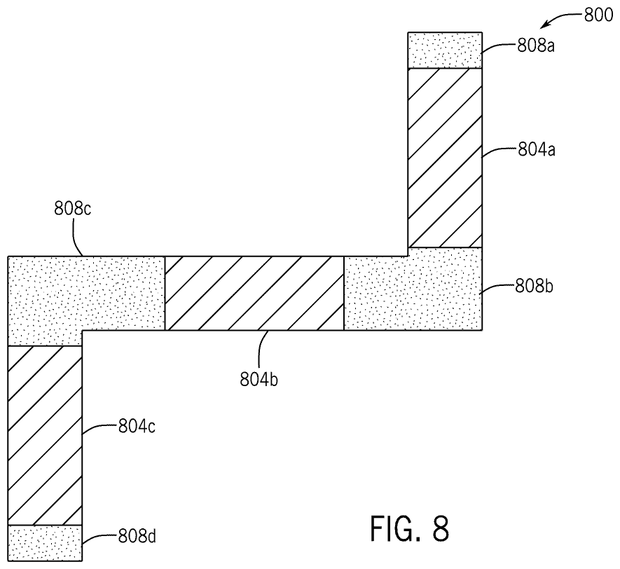

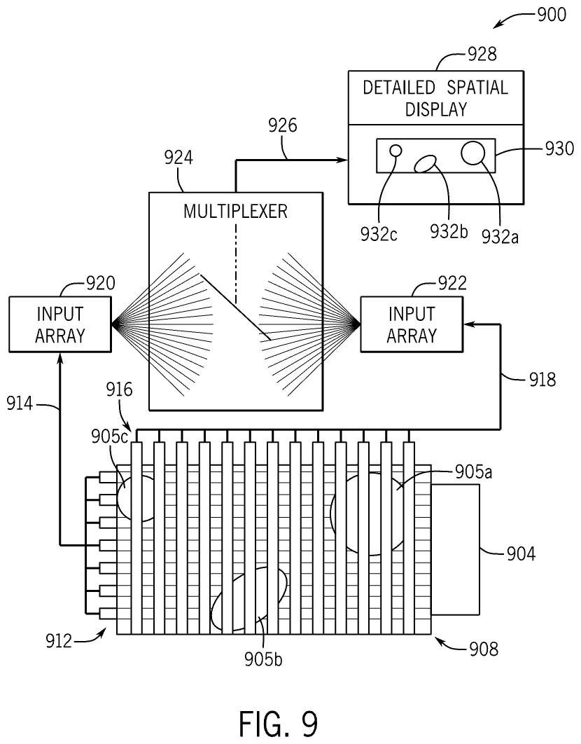

Upon reaching both the first electrode mesh 220 and the second electrode mesh 228, the conducting fluid 236 may define an electrical bridge or circuit between the meshes 220, 228. For example, the conducting fluid 236 may be a fluid that generally allows for the conducing of electricity therethrough, and therefore on contact with the meshes 220, 228, electrical current may flow between the meshes 220, 228 across the insulative material 224. More generally, the conducting fluid 236 may have an electrical resistivity property that is less (including substantially less) than an electrical resistivity property of the insulative material 224. Accordingly, upon contact of the conducting fluid 220 with the meshes 220, 228, the electrical resistivity between the meshes 220, 228 may change (e.g., the electrical resistivity between the meshes 220, 228 as measured spatially across the insulative layer 224). As described herein in greater detail with reference to FIG. 7, said change in electrical resistivity may be measured via the output wires 206a, 206b and correlated with a leak event. For example, as the resistivity between the meshes 220, 228 changes relative to a baseline output signal of the meshes 220, 228, the meshes 220, 228 may output a changed electrical signal via the output wires 206a, 206b that may indicate that a leak event has occurred. In some cases, the changed electrical signal may further indicate a magnitude of the leak event whereby a magnitude of the change of the electrical signal may indicate a magnitude of the leak (e.g., where the change in the electrical resistance between the meshes 220, 228 may be proportional to the magnitude of the conducting fluid that traverses the leak path 244. Further, and as described in greater detail herein with reference to the multi-nodal and multiplexer configurations of FIGS. 8 and 9, respectively, the change in the electrical signal may be indicative of a location of the leak event, such as where the meshes 220, 228 are associated with a specifically located process equipment of a nodal array and/or where the meshes 220, 228 are meshes of a two-axis input array, among other possibilities.

Furthermore, it will be appreciated that in some examples, the second electrode mesh 228 may be omitted entirely from the composite material 204, and the leak detection apparatus 200 may operate to detect the leak of the conducting fluid absent the second electrode mesh 228. For example, with continued reference to FIG. 4, the second electrode mesh 228 may be omitted and the insulative material 224 may be pressed directly against and otherwise engaged with the pipe wall 232. As such, the conducting fluid 236 may propagate along the leak path 244, through the insulative material, and to and through the first electrode mesh 220. As described herein, the insulative material 228 may be an electrically insulative material such that electric current is impeded or restricted from flowing through the insulative material 228. The pipe wall 232 may be formed from an electrically conductive material. Accordingly, absent a leak event, the insulative material 224 may operate to impede the flow of electrical current between the pipe wall 232 and the first electrode mesh 220. Upon a leak event, the conducting fluid 236 may propagate through the insulative material 224 and first electrode mesh 220, as described herein, and create an electrical bridge or circuit spanning the pipe wall 232 and the first electrode mesh 220 spatially across the insulative material 224. Such completion of an electrical circuit between the pipe wall 232 and the first electrode mesh 220 may cause a corresponding change in an electrical output of the first electrode mesh 220 at the wire 202a. The change in the electrical output may be compared to a baseline output of the first electrode mesh 220 to determine a leak event and associated magnitude and location of the same, as described herein.

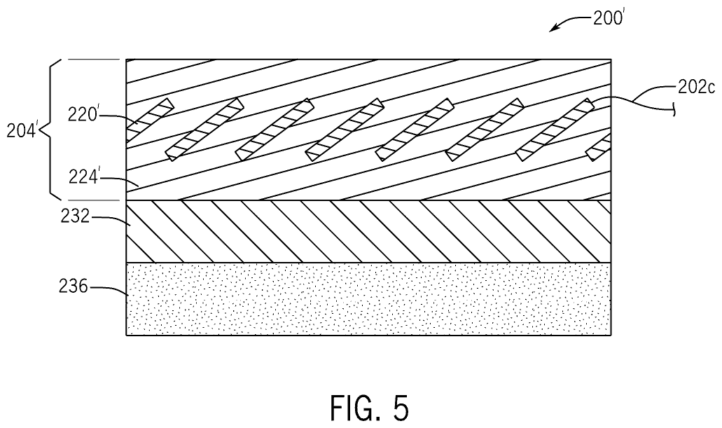

With reference to FIG. 5, a second example leak detection apparatus of the leak detection apparatus of FIG. 2 is shown, a leak detection apparatus 200′. The leak detection apparatus 200′ may be substantially analogous to the leak detection apparatus 200 described herein in relation to FIGS. 3 and 4 and be configured to detect a leak of the conducting fluid 236 through the pipe wall 232 and/or other process equipment using a composite structure 204′, insulative material 224′, and wire 202c; redundant explanation of which is omitted herein for clarity.

Notwithstanding the foregoing similarities, the leak detection apparatus 200′ is shown in FIG. 5 as including a series of conducting fibers 220′ impregnated within the insulative material 224′. In this regard, the conductive fibers 220′ and the insulative material 224′ may cooperate to form an insulative “wick” that may be used to facilitate detection of the conducting fluid 236 at the composite structure 204′. For example, the insulative material 224 may operate to “soak up” the conducting fluid 236 such that the conducting fluid 236 generally permeates through the insulative material 224. The conducting fluid 236 may therefore permeate the insulative material 224 and form electrical connections between and across the conductive fibers 220′ impregnated therein. The composite material 204′ may generally be configured to product an output an electrical wire 202c. Said output at the electrical wire may change relative to, and be responsive, to a leak event whereby the conducting fluid 236 soaks into the insulative material 224′ and extends among the conductive fibers 220′.

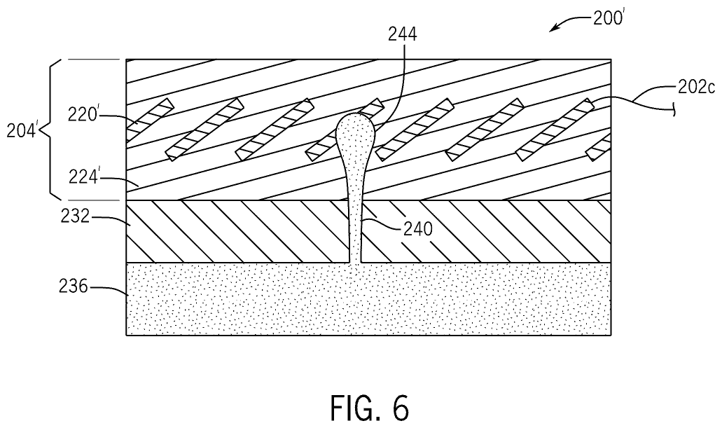

For example, and as shown in relation to FIG. 6, a leak event may occur in which the conducting fluid 236 propagates through a failure passage 240 and along a leak path 244, as described herein in relation to FIG. 4. As shown in the example of FIG. 6, the leak path 244 may extend into the insulative material 224′ and to and among the conductive fibers 220′. The insulative material 224′ and the conductive fibers 220′ may form the insulative wick described herein such that the conducting fluid 236 may be absorbed by and permeate through the insulative material 224′ and electrically couple the conductive fibers 220′ held therein. Upon the occurrence of the conducting fluid 236 propagating in this manner, the electrical resistance among the conductive fibers 220′ may change, and thus any signal output by the insulative wick at output wire 202c may change correspondingly. Further, the change of any electrical signal at the output wire 202c may be subsequently analyzed to determine the occurrence of a leak event, including the magnitude and location of said leak event, according to the techniques described herein.

Any of the leak detection apparatuses disclosed herein may be used in combination with one or more computing devices to establish a leak detection system that is configured to detect leaks (including optionally the magnitude and location of said leaks), according to the techniques described herein. With reference to FIG. 7, one example leak detection system 700 of the present disclosure is shown. The leak detection system 700 may generally include a leak detection apparatus 704 that is configured to detect a leak of conducting fluid from any manner of process equipment associated therewith. The leak detection apparatus 704 may be substantially analogous to any of the leak detection apparatuses described herein, including the leak detection apparatus 200, the leak detection apparatus 200′ and/or other leak detection apparatuses and variations described and contemplated herein. The leak detect apparatus 704 is shown spatially positioned in a radiation zone 708. The radiation zone 708 may be a zone or an environment that exhibits generally high radiation, high temperature, and/or other characteristic that defines the radiation zone 708 as a generally harsh environment. Despite the harsh environment, the leak detection apparatus 704 may be configured to detect a leak of a conducting fluid according to the techniques described herein in relation to FIGS. 2-6. For example, the leak detection apparatus 704 may be configured to output a change in an electrical parameter responsive to a contact with said conducting fluid. The change in the output electrical parameter may generally occur in a repeatedly detectable manner despite the presence of the harsh environment.

Notwithstanding the ability of the leak detection apparatus 704 to function in such harsh environments, any associated computing devices and associated electronic equipment may be susceptible to reduced performance in such harsh environments. In this regard, the associated computing devices and electronic equipment may be required to kept substantially away from and outside of the harsh environment. As shown in FIG. 7, the leak detection apparatus 704 may be positioned within the radiation zone 708 and within a zone defined by a radiation shielding 712. The radiation shielding 712 may generally define one or more radiation, thermal, personnel, structural and/other barriers between the radiation zone 708 and the area outside of the radiation zone 708. For example, the shield 120 and the enclosure 130 shown and described in relation to FIG. 1 herein may be example structures of the form the radiation shielding 712 of FIG. 7.

The leak detection apparatus 704 is position within the radiation zone 708 and within the radiation shielding 712, while the associated computing devices and electronics equipment are positioned outside of the radiation zone 708 and the radiation shielding 712, as shown in FIG. 7. The leak detection apparatus 704, in operation, may output various electric signals to the computing devices and electronics equipment outside of the radiation zone 708. For example, during a normal operation (i.e., a non-leak period), the leak detection apparatus 704 may output a baseline electrical signal. Subsequently, during a leak event, the leak detection apparatus 704 may output one of a variety of electrical signals that are changed from the baseline electrical signal and that may be indicative of the leak event. In this regard, FIG. 7 shows a leak detection apparatus 704 associated with a first connection 706a and a second connection 706b. The first connection 706a may be a wire bundle and/or other electrical coupling that carries the electrical output or signal of the leak detection apparatus 704 through the radiation zone 708. The second connection 706b may similarly be a wire bundle and/ot other electrical coupling that carries the electrical output or signal of the leak detection apparatus 704 outside of the radiation zone 708 for analysis by various computing devices and electrical components. In some cases, the first and second connections 706a, 706b may be segments of a common wire bundle or electrical coupling. In other cases, the first connection 706a may be constructed in a manner and rated to withstand the harsh environment of the radiation zone 708 (e.g., via certain insulative, structural, and/other materials), whereas the second connection 706b may not require such rating and construction to the extent that the second connection 706b passes through a less harsh environment.

The second connection 706b is shown in FIG. 7 as extending to the preamplifier 716. The preamplifier 716 may generally be configured to convert the relatively weak signal that is output from the leak detection apparatus 704 into an output signal that is strong enough for further processes. In some cases, the preamplifier 715 may be generate the output signal to be noise-tolerant and/or otherwise engage in some manner of filtering of the signal from the leak detection apparatus 704 such that the signal may be effectively analyzed. FIG. 7 further shows the preamplifier 716 generating an output signal 718 that extends to an ohmmeter 720. The ohmmeter 720 may generally be any device that is capable of reading electrical resistance. In this regard, the ohmmeter 720 may be operable to determine the electrical resistance generally associated with the electrical signal output by the leak detection apparatus 704, and further to determine any changes in said resistance (e.g., such as changes in the resistance that may be indicative of a leak event). While an ohmmeter 720 is shown in FIG. 7 for purposes of illustration, the ohmmeter 720 is one example electrical instrument that may be used. In other cases, the system 700 may include a multimeter for capacitive detection and/or other devices based on a configured of the leak detection apparatus and associated output electrical signals. In FIG. 7, the ohmmeter 720 is shown as outputting an electrical signal 722 to a chart 724. The chart 724 shows generally a change in an electrical resistance of the output electrical signal over time. By way of example, the chart 724 shows an electrical resistance of the output electrical signal abruptly dropping after a period of time. Such abrupt drop in the resistance may be indicative of a leak event, for example, due to the electrical circuit or bridge formed by the conducting fluid between one or more layers of the electrode meshes, as described herein in relation to FIGS. 3-6.

In some example implementations, the various leak detection apparatuses of the present disclosure may be arranged with one another to establish a multi-nodal configuration of leak detection apparatuses. The multi-nodal configuration may be used to facilitate the determination of the location of a leak event relative to the associated process equipment. For example, it may be desirable to arrange multiple leak detection apparatus relative to a one or more segments of process equipment, such as arranging a leak detection apparatus relative to one or more segments of a pipe that carries the conducting fluid. In this regard, in response to a leak event from the process equipment, the leak detection apparatuses may cooperate with one another to determine a location of the leak event. For example, the individual leak detection apparatuses may be arranged such that an electrical output signal is generated responsive to a given apparatus of the leak detection apparatuses of the multi-nodal configuration. The given apparatus may be associated with a particular location on the process equipment, and as such, the output electrical signal may be correlated to said location upon the change of the signal indicative of the leak event.

With reference to FIG. 8, a multi-nodal configuration 800 is shown. The multi-nodal configuration 800 may include a first leak detection apparatus 804a, a second leak detection apparatus 804b, and a third leak detection apparatus 804c. The leak detection apparatus 804a-804c may be substantially analogous to any of the leak detection apparatuses described herein, including the leak detection apparatus 200, the leak detection apparatus 200′, the leak detection apparatus 704, and/or other leak detection apparatuses and variations described and contemplated herein. As shown in FIG. 8, the leak detection apparatuses 800 may be coupled to one another in series via a collection of nodes. For example, the first leak detection apparatus 804a may be coupled between a first node 808a and a second node 808b. Further, the second leak detection apparatus 804b may be coupled between the second node 808b and a third node 808c. Further, the third leak detection apparatus 804c may be coupled between the third node 808c and a fourth node 808d.

In operation, each of the leak detection apparatuses 804a-804c may be associated with a different segment or location of an item of process equipment, such as a process pipe carrying a conducting fluid (e.g., molten salt) therein. For example, the first leak detection apparatus 804a may be associated with a first segment of said process pipe, the second leak detection apparatus 804b may be associated with a second segment of said process pipe, and the third leak detection apparatus 804c may be associated with a third segment of said process pipe. Accordingly, the first leak detection apparatus 804a may output a changed electrical signal responsive to leak event at the first pipe segment, the second leak detection apparatus 804b may output a changed electrical signal responsive to a leak event at the second pipe segment, and the third leak detection apparatus 804c may output a changed electrical signal responsive a leak event at the third pipe segment. The leak detection apparatus 804a-804c may output said electrical signals to one or more computing devices according to the techniques described herein. In this regard, said one or more computing devices may detect a change in the electrical signal from each apparatus, and associated the change with a location of the leak event on the process pipe based on the location of given leak detection apparatus from which the signal originates relative to the respective pipe segment of the process pipe.

In other example implementations, the leak detection apparatuses of the present disclosure may be used to more granularly map a 2D position and optionally shape of a leak event. For example, and as shown in FIG. 9, a leak detection 908 may be used as part of a leak detection system 900 that is capable of mapping a 2D position and shape of leak events relative to associated process equipment. For example, the leak detection apparatus 908 may generally be substantially analogous to the leak detection apparatus 200, the leak detection apparatus 200′, the leak detection apparatus 704, the leak detection apparatus 804a-804c, and/or other leak detection apparatuses and variations described and contemplated herein. For example, the leak detection apparatus 908 may be associated with a process equipment 904 and be configured to output one or more electrical signals in response to a leak event of conducting fluid form the process equipment 904.

Notwithstanding the foregoing, the leak detection apparatus 908 may including a first axis input array 912 and a second axis input array 916. The first axis input array 912 may be or include one or more electrode meshes that span a segment of a first axis of the leak detection apparatus 908 (e.g., a horizontal or X axis). The second axis input array 916 may be or include one or more electrode meshes that span a segment of a second axis of the leak detection apparatus 908 (e.g., a vertical or Y axis or otherwise an axis that runs perpendicular to the first axis). The first and second axis input arrays 912, 916 may be separated by an electric insulator (not shown in FIG. 9).

In operation, the first and second input arrays 912, 916 may output a baseline electric signal via first output 914 and second output 918, respectively. In response to a leak event from the process equipment 904, the conducting fluid may cause a change in an electrical signal output at the first and second outputs 914, 918, based in part on a location of the leak event. For example, and as shown in FIG. 9, during a leak event, the process equipment 904 may generally emit a conducting fluid at leak regions 905a, 905b, 905c. The conducting fluid present at the respective leak region 905a, 905b, 905c may cause a change in electrical parameters (e.g., electrical resistivity) between the first axis input array 912 and the second axis input array 916. For example, the resistance between given electrode spans of the first axis input array 912 and given spans of the second axis input array 916 that are proximal to a respective leak region may be reduced between the conducting fluid may form an electrical bridge or circuit between said spans. In turn, this change in the electrical output signal is propagate to an input array module 920 via the first output 914 for the respective first axis input array 912. Further, this change in the electrical output signal is propagated to an input array module 922 via the second output 918 for the respective second axis input array 916. As shown in FIG. 9, the input array modules 920, 922 are each associated with a multiplexer unit 924. The multiplexer unit 924 may operate as any appropriate data selector or other device whereby the multiple inputs of the respective arrays 920, 922 may be selected and output appropriately to a common output signal 926. In some cases, the multiplexer unit 924 may operate to create a digital signal representative of a spatial leak detection map as generated from the set of linearly pixelated electrodes of the respective input arrays 912, 916. In this regard, the output signal 926 may be provided to generate the detailed spatial display 928 shown in FIG. 9. The detailed spatial display 928 shows a process equipment representation 930 along with a graphical representation of leak event locations 932a, 932b, 932c relative to the process equipment representation 930. The graphical representation of the leak event locations 932a, 932b, 932c may correspond or otherwise provide information relating to the physical location of the leak region 905a, 905b, 905c on the process equipment 904.

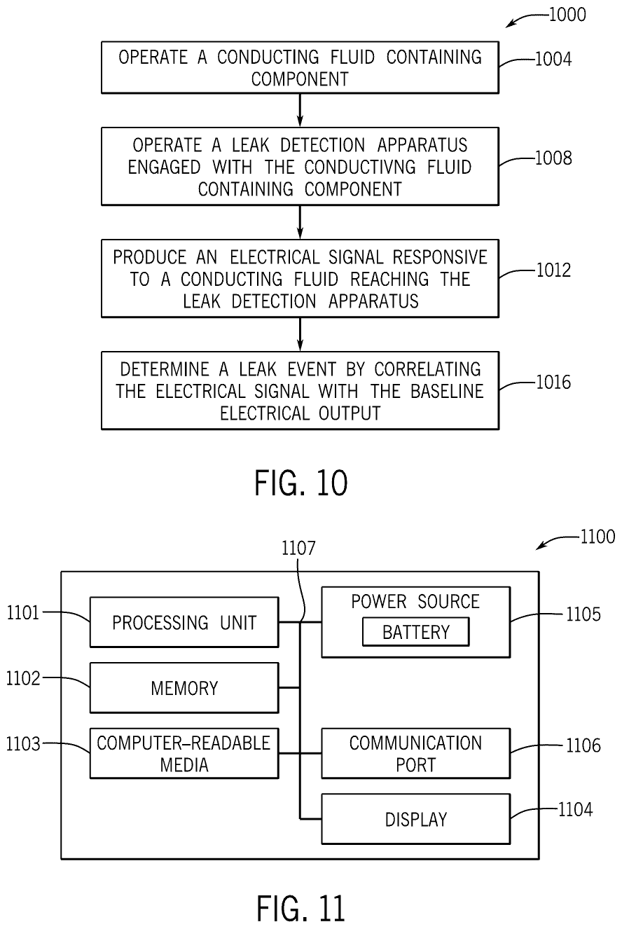

FIG. 10 depicts a flow diagram of an example method of determining a leak event. For example, at operation 1004, a conducting fluid containing component is operated. For example, and with reference to FIGS. 1 and 2, a molten salt reactor system 100 may be operated whereby a conducting fluid (e.g., a molten salt) is circulated through various process equipment, as described herein. The conducting fluid may flow through pipe segments 112a, 112b, 112c, 112d, 112e about a molten salt loop. At operation 1008, a leak detection apparatus that is engaged with the conducting fluid containing component is operated. For example, and with continued reference to FIGS. 1 and 2, a leak detection apparatus 200 may be operated. The leak detection apparatus 200 may be associated with the pipe segment 112d and may be used to detect an leak of the conducting fluid therefrom. During operation, prior to any leak event, the leak detection apparatus 200 may output certain baseline electrical signals via wire bundle 202. For example, the wire bundle 202 may transmit the baseline electrical signals to one or more remote computers at which the electrical signals may be analyzed to determine that a change in said electrical signals corresponds to a leak event.

At operation 1012, an electrical signal responsive to a conducting fluid reaching the leak detection apparatus is produced. For example, and with reference to FIGS. 3, 4, and 7, a conducting fluid 236 may be released from a pipe wall 232 and travel through a failure passage 240 and along a leak path 244. The leak path 244 may permeate through the second electrode mesh 228, the insulative layer 224, and the first electrode mesh 220. In this regard, the conducting fluid 236 may serve to establish an electrical bridge or circuit between the first and second electrode meshes 220, 228 across the insulative layer 224. The electrical circuit or bridge may reduce an electrical resistance between the meshes 220, 228, which may result in a change in an electrical output from the meshes 220, 228 at the wire bundles 202a, 202b. At operation 1016, a leak event is determined by correlating the electrical signal with the baseline electrical output. For example, and with continued reference to FIGS. 3, 4, and 7, the leak detection apparatus 704 may output one or more electric signals to a computing device that is arranged outside of the radiation zone 708. The computing device may include or otherwise be associated with a preamplifier, an ohmmeter, and visual display, among other components. In one example, upon said leak event, the conducting fluid may form a circuit or bridge between the various meshes described herein. Accordingly, the signal output by the leak detection apparatus 704 may indicate a reduced electrical resistance because rather than be separated by the insulative material, the meshes may be electrically coupled via the conducting fluid. Said reduced electrical resistance may be analyzed and plotted at chart 724 and/or other visual display. The abrupt drop in resistance, as shown in chart 724, may be indicative of said leak event. In some cases, where a multiplexer configuration is utilized, said changes in the output electrical signals may be analyzed to determine a spatial display of the leak event relative to the process equipment, as described herein in relation to FIG. 9.

FIG. 11 depicts a functional block diagram of a computing system 1100. The schematic representation in FIG. 11 is generally representative of any types of systems and configurations that may be used to receive and process the various signals from the leak detection apparatus described herein. For example, the computing system 1100 may be used with or included within any of the leak detection apparatuses described herein to form or establish a leak detection system, and to perform any of the functions described herein. In this regard, the computing system 1100 may include any appropriate hardware (e.g., computing devices, data centers, switches), software (e.g., applications, system programs, engines), network components (e.g., communication paths, interfaces, routers) and the like (not necessarily shown in the interest of clarity) for use in facilitating any appropriate operations disclosed herein.

As shown in FIG. 11, the computing system 1100 may include a processing unit or element 1101 operatively connected to computer memory 1102 and computer-readable media 1103. The processing unit 1101 may be operatively connected to the memory 1102 and computer-readable media 1103 components via an electronic bus or bridge (e.g., such as system bus 1107). The processing unit 1101 may include one or more computer processors or microcontrollers that are configured to perform operations in response to computer-readable instructions. The processing element 1101 may be a central processing unit of control system 1100. Additionally or alternatively, the processing unit 1101 may be other processors within the device including application specific integrated chips (ASIC) and other microcontroller devices.

The memory 1102 may include a variety of types of non-transitory computer-readable storage media, including, for example, read access memory (RAM), read-only memory (ROM), erasable programmable memory (e.g., EPROM and EEPROM), or flash memory. The memory 1102 is configured to store computer-readable instructions, sensor values, and other persistent software elements. Computer-readable media 1103 may also include a variety of types of non-transitory computer-readable storage media including, for example, a hard-drive storage device, a solid state storage device, a portable magnetic storage device, or other similar device. The computer-readable media 1103 may also be configured to store computer-readable instructions, sensor values, and other persistent software elements.

In this example, the processing unit 1101 is operable to read computer-readable instructions stored on the memory 1102 and/or computer-readable media 1103. The computer-readable instructions may adapt the processing unit 1101 to perform the operations or functions described above with respect to FIGS. 1-10. The computer-readable instructions may be provided as a computer-program product, software application, or the like.

As shown in FIG. 11, the computing system 1100 may also include a display 1104. The display 1104 may include a liquid-crystal display (LCD), organic light emitting diode (OLED) display, light emitting diode (LED) display, or the like. If the display 1104 is an LCD, the display may also include a backlight component that can be controlled to provide variable levels of display brightness. If the display 1104 is an OLED or LED type display, the brightness of the display 1104 may be controlled by modifying the electrical signals that are provided to display elements.

The computing system 1100 may also include a battery that is configured to provide electrical power to the components of computing system 1100. The battery may include one or more power storage cells that are linked together to provide an internal supply of electrical power. In this regard, the battery may be a component of a power source 1105 (e.g., including a charging system or other circuitry that supplies electrical power to components of the computing system 1100). The battery may be operatively coupled to power management circuitry that is configured to provide appropriate voltage and power levels for individual components or groups of components within the computing system 1100. The battery, via power management circuitry, may be configured to receive power from an external source, such as an AC power outlet or interconnected computing device. The battery may store received power so that the computing system 1100 may operate without connection to an external power source for an extended period of time, which may range from several hours to several days.

The computing system 1100 may also include a communication port 1106 that is configured to transmit and/or receive signals or electrical communication from an external or separate device. The communication port 1106 may be configured to couple to an external device via a cable, adaptor, or other type of electrical connector. In some embodiments, the communication port 1106 may be used to couple the computing system 1100 with a computing device and/or other appropriate accessories configured to send and/or receive electrical signals. The communication port 1106 may be configured to receive identifying information from an external accessory, which may be used to determine a mounting or support configuration. For example, the communication port 1106 may be used to determine that the computing system 1100 is coupled to a mounting accessory, such as a particular type of stand or support structure.

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. A leak detection system comprising
a leak detection apparatus comprising an electrode mesh and an insulative layer associated with the electrode mesh, wherein the insulative layer is engageable with a conducting fluid containing component, and wherein the electrode mesh is configured to output an electric signal responsive to a conducting fluid reaching the electrode mesh through the insulative layer; and
a computing device configured to receive said electrical signal and associate said electrical signal with a leak event by correlating said electrical signal with a baseline electrical output of the electrode mesh.

2. The system of claim 1, wherein
the insulative layer comprises an insulative wick, and
the electrode mesh comprises conductive fibers impregnated within the insulative wick.

3. The system of claim 1, wherein
the electrode mesh comprises a first electrode mesh,
the leak detection apparatus further comprises a second electrode mesh, and
the insulative layer is arranged between the first electrode mesh and the second electrode mesh and electrically insulating the first electrode mesh and the second electrode mesh from one another.

4. The system of claim 3, wherein
the second electrode mesh is arranged against the conducting fluid containing component, and
the first electrode mesh generates the electrical signal responsive to the conducting fluid reaching the first electrode mesh through the insulative layer and the second electrode mesh.

5. The system of claim 4, wherein the first electrode mesh generates the electrical signal responsive to the conducting fluid reducing a resistance between the first electrode mesh and the second electrode mesh.

6. The system of claim 1, wherein the conducting fluid comprises a fuel salt including a fissile material therein.

7. The system of claim 1, wherein the conducting fluid comprises a natural and/or artificial fluid with an electrical response, including one or more of a liquid metal, water, a nano fluid and/or another fluid.

8. The system of claim 1, wherein
the system further comprises a plurality of the leak detection apparatuses of claim 1, and
the plurality of leak detection apparatuses is arranged in multi-node configuration with each leak detection apparatus associated with a different fluid containing component, all of which including the conducting fluid.

9. The system of claim 8, wherein each leak detection apparatus is configured to output a fluid containing component specific signal responsive the conducting fluid reaching the respective leak detection apparatus via the corresponding fluid containing component associated therewith.

10. The system of claim 1, wherein
electrode mesh defines a multiplexer configuration including one or more layers of linearly pixelated electrodes, and
the electrode mesh is configured to output signal indicative of a location of the leak event relative to the fluid containing component.

11. A nuclear reactor system comprising
a conducting fluid containing component including a conducting fluid therein;
a leak detection apparatus engaged with an exterior of the conducting fluid component and configured to produce an electrical signal responsive to a detection of the conducting fluid at the leak detection apparatus;
a radiation barrier at least partially encompassing the conducing fluid containing component and the leak detection apparatus; and
a computing device, outside of the radiation barrier, and configured to receive said electrical signal and associate said electrical signal with a leak event by correlating said electrical signal with a baseline electrical output of the leak detection apparatus.

12. The system of claim 11, wherein the conducing fluid comprises a fuel salt including a fissile material therein.

13. The system of claim 11, wherein the conducting fluid containing component comprises a reactor vessel or a piping fluidly coupled therewith for circulation of a fuel salt.

14. The system of claim 11, wherein the radiation barrier comprises a reactor vessel.

15. The system of claim 14, wherein the radiation barrier further comprises a thermal management vessel within the reactor enclosure, the thermal management vessel encompassing a reactor vessel and a drain tank of a molten salt loop.

16. The system of claim 11, wherein the leak detection apparatus further comprises an electrode mesh and an insulative layer associated with the electrode mesh, wherein the insulative layer is engageable with the conducting fluid containing component, and wherein the electrode mesh is configured to output the electric signal responsive to the conducting fluid reaching the electrode mesh through the insulative layer.

17. A method comprising
operating a conducting fluid containing component by propagating a conducting fluid therethrough;
operating a leak detection apparatus engaged with an exterior of the conducting fluid containing component by generating a baseline electrical output therefrom;
producing an electrical signal responsive to the conducting fluid reaching the leak detection apparatus; and
determining a leak event by correlating said electrical signal with the baseline electrical output.

18. The method of claim 17, wherein
the leak detection apparatus comprises an electrode mesh and an insulative layer associated with the electrode mesh, and
the producing of the electrical signal further comprises producing said electrical signal responsive to the conducting fluid reaching the electrode mesh through the insulative layer.

19. The method of claim 17, wherein
the electrode mesh comprises a first electrode mesh,
the leak detection apparatus further comprises a second electrode mesh,
the insulative layer is arranged between the first electrode mesh and the second electrode mesh and electrically insulating the first electrode mesh and the second electrode mesh from one another, and
the producing of the electrical signal further comprises producing said electrical signal responsive to the conducting fluid reaching the first electrode mesh through the insulative layer and the second electrode mesh and reducing a resistance between the first electrode mesh and the second electrode mesh.

20. The method of claim 17, wherein the determining of the leak further comprises determining a location of the leak event relative to a geometry of the conducting fluid containing component.

21. The method of claim 17, further comprising analyzing the electrical signal outside of a radiation shielding encompassing the conducting fluid containing component and the leak detection apparatus.

22. The method of claim 17, wherein the conducting fluid comprises a fuel salt including a fissile material therein.

23. The method of claim 17, wherein the conducting fluid comprises a natural and/or artificial fluid with an electrical response, including one or more of a liquid metal, water, a nano fluid and/or another fluid.
